(19) United States
(12) Patent Application Publication
(10) Pub. No.: US 2013/0153401 A1
(43) Pub. Date: Jun. 20, 2013

(54) Brine purification process

(71) Applicants: Patrick Gilbeau, Braine-le-Comte (BE); Philippe Krafft, Rhode Saint Genese (BE); Jerome Ligot, Alessandria (IT); Valentine Smets, Spinette Marengo (AL) (IT); Giancarlo Iavarone, Virginal Samme (BE)

(72) Inventors: Patrick Gilbeau, Braine-le-Comte (BE); Philippe Krafft, Rhode Saint Genese (BE); Jerome Ligot, Alessandria (IT); Valentine Smets, Spinette Marengo (AL) (IT); Giancarlo Iavarone, Virginal Samme (BE)

(73) Assignee: SOLVAY SA, Brussels (BE)

(21) Appl. No.: 13/818,753

(22) PCT Filed: Aug. 22, 2011
(86) PCT No.: PCT/EP2011/064337

§ 371 Date: Feb. 25, 2013

(30) Foreign Application Priority Data
Aug. 27, 2010 (FR) 1056820

(51) Int. Cl. C01D 3/14

(52) U.S. Cl. CPC C01D 3/14
USPC 203/31; 203/87; 203/49; 203/36; 203/37; 203/29; 203/44; 203/39; 203/41; 203/32; 203/48; 203/47

(57) ABSTRACT

A process for purifying a brine of organic compounds comprising: (a) supplying a brine that comprises at least one organic compound; (b) feeding at least one stripping zone with the brine from (a) and at least one stripping agent; (c) withdrawing from the stripping zone at least one fraction (I) consisting essentially of brine, the content of the organic compound being lower in fraction (I) than in the brine from step (a), and at least one fraction (II) consisting essentially of the stripping agent; wherein the temperature (T₁) of the hotter fraction of the two fractions (I) and (II) and the temperature (T₂) of the colder fraction of the two fractions (I) and (II), such temperatures expressed in degrees Celsius being the temperatures measured before any possible thermal conditioning which might be carried out before and/or during their withdrawal from the stripping zone, correspond to the following formula:

6×10⁻⁷(T₁)^{3.7294}≦T₂<T₁

The present application claims benefit of French patent application n° 1056820 filed on Aug. 27, 2010, the content of which is incorporated herein by reference for all purposes.

Should the disclosure of any of the patents, patent applications, and publications which are incorporated herein by reference conflict with the description of the present application to the extent that it may render a term unclear, the present description shall take precedence.

The present invention relates to a process for purifying a brine. The present invention relates more specifically to a process for purifying a brine of organic compounds.

International application WO 2008/152043 filed in the name of SOLVAY SA discloses the stripping of a brine comprising organic compounds. The temperature conditions disclosed for the stripping operation may be a source of problems in the stripping zone. Thus, temperatures that are too high may lead to degradations of the organic products and the use of costly materials that are resistant to the brine under these conditions, and temperatures that are too low may make it necessary to use uncommon and expensive coolants.

The present invention aims to overcome these problems by providing a process for purifying a brine of organic compounds comprising:
(a) supplying a brine that comprises at least one organic compound;
(b) feeding at least one stripping zone with the brine from (a) and at least one stripping agent;
(c) withdrawing from the stripping zone at least one fraction (I) essentially constituted of brine, the content of organic compound of which is lower than in the brine from (a) and at least one fraction (II) essentially constituted of stripping agent;
   in which the temperature, expressed in degrees Celsius (T₁), of the hottest fraction of the two fractions (I) and (II) and the temperature, expressed in degrees Celsius (T₂), of the coldest fraction of the two fractions (I) and (II), said temperatures being the temperatures measured before any possible thermal conditioning which might be carried out before and/or during the withdrawal thereof, correspond to the following formula:

6×10⁻⁷(T₁)^{3.7294}≦T₂<T₁

In the process according to the invention, the temperature T₂ is preferably less than or equal to 0.9752 (T₁)^{0.9991} and more preferably less than or equal to 0.8967 (T₁)^{1.0147}.

In the process according to the invention, the temperature T₂ is preferably greater than or equal to 5×10⁻⁵ (T₁)^{2.8779}, more preferably greater than or equal to 0.0058 (T₁)^{1.9415}, even more preferably greater than or equal to 0.0593 (T₁)^{1.4859}, more preferably still greater than or equal to 0.5342 (T₁)^{1.088} and very particularly preferably greater than or equal to 0.7535 (T₁)^{1.0325}.

In one embodiment of the process according to the invention that is very suitable, the stripping zone consists of a stripping column.

The essential feature of the present invention lies in the combination of the values of the temperatures of the hottest fraction and of the coldest fraction withdrawn from the stripping zone.

By carrying out the stripping under the temperature conditions mentioned:
less degradation of the organic products in the stripping zone is observed;
it is not necessary to use specific and costly materials for producing the equipment of the stripping zone; and
it is not necessary to use specific and expensive coolants for the stripping zone.

In the embodiment of the process according to the invention that is very suitable, where the stripping zone consists of a stripping column, the combination of the values of the temperatures of the hottest fraction and of the coldest fraction withdrawn from the stripping zone has the following advantages:
less degradation of the organic products in the stripping column is observed;
it is not necessary to use specific and costly materials for producing the stripping column and its internals;
it is not necessary to use specific and expensive coolants for the stripping column;
it is possible to work with columns of reasonable height; and
the mechanical stresses in the column are minimized.

In the process according to the invention, the term “brine” is understood to mean an aqueous composition containing at least one salt. The salt may be an organic salt, an inorganic salt or a mixture of the two. An inorganic salt is a salt whose constituent anions and cations do not contain a carbon-hydrogen bond. The inorganic salt may be chosen from the group constituted of metal chlorides, metal sulphates, metal hydrogen sulphates, metal hydroxides, metal carbonates, metal hydrogen carbonates, metal phosphates, metal hydrogen phosphates, metal borates and mixtures of at least two thereof. Alkali and alkaline-earth metal chlorides are preferred. Sodium and potassium chlorides are more particularly preferred and sodium chloride is very particularly preferred.

The salt content of the brine is generally greater than or equal to 5 g of salt/kg of brine, often greater than or equal to 10 g/kg, frequently greater than or equal to 50 g/kg, commonly greater than or equal to 80 g/kg, preferably greater than or equal to 90 g/kg, more preferably greater than or equal to 100 g/kg, even more preferably greater than or equal to 140 g/kg, more preferably still greater than or equal to 160 g/kg, and very particularly preferably greater than or equal to 180 g/kg. This salt content is habitually less than or equal to 270 g of salt/kg of brine, preferably less than or equal to 250 g/kg and very particularly preferably less than or equal to 230 g/kg.

A brine for which the sodium chloride content is greater than or equal to 190 g/kg of brine and less than or equal to 220 g/kg is very particularly suitable.

A brine for which the content of sodium salts is greater than or equal to 200 g/kg is also very particularly suitable.

The brine may have a neutral, acid or basic pH.

In the process according to the invention, the organic compound may be chosen from the group constituted of aliphatic compounds, aromatic compounds or mixtures of at least two thereof. These compounds may optionally contain at least one heteroatom chosen from the group constituted of halogens, preferably fluorine, chlorine, bromine and iodine, chalcogens, preferably oxygen or sulphur, nitrogen, phosphorus and mixtures of at least two thereof. The heteroatom is preferably oxygen.

The organic compound may be as described in application WO 2009/095429 in the name of SOLVAY (Société Anonyme), of which the content, and more specifically the passage from page 2, line 16, to page 3, line 11, is incorporated by reference.

The organic compound is preferably chosen from the group constituted of epichlorohydrin, dichloropropanols and mixtures of at least two thereof. Among the dichloropropanols, 1,3-dichloropropan-2-ol and 2,3-dichloropropan-1-ol are often encountered. The organic compound is often chosen from mixtures of epichlorohydrin and of dichloropropanols.

In the process according to the invention the content of organic compound in the brine before the stripping operation is generally greater than or equal to 0.1 g/kg of brine, often greater than or equal to 1 g/kg, in a lot of cases greater than or equal to 5 g/kg, frequently greater than or equal to 10 g/kg and more specifically greater than or equal to 20 g/kg. This content is generally less than or equal to 250 g/kg, often less than or equal to 150 g/kg and frequently less than or equal to 100 g/kg.

In the process according to the invention, when the organic compound is chosen from mixtures of epichlorohydrin and of dichloropropanols, the content of epichlorohydrin in the brine before the stripping operation is generally greater than or equal to 0.1 g/kg of brine, often greater than or equal to 1 g/kg, in a lot of cases greater than or equal to 5 g/kg, frequently greater than or equal to 8 g/kg and more specifically greater than or equal to 10 g/kg. This content is generally less than or equal to 100 g/kg, often less than or equal to 50 g/kg and frequently less than or equal to 25 g/kg.

In the process according to the invention, when the organic compound is chosen from mixtures of epichlorohydrin and of dichloropropanols, the sum of the contents of 1,3-dichloropropan-2-ol and 2,3-dichloropropan-1-ol in the brine before the stripping operation is generally greater than or equal to 0.2 g/kg of brine, often greater than or equal to 0.5 g/kg, in a lot of cases greater than or equal to 0.7 g/kg, frequently greater than or equal to 1 g/kg and more specifically greater than or equal to 1.5 g/kg. This content is generally less than or equal to 100 g/kg, often less than or equal to 50 g/kg and frequently less than or equal to 25 g/kg. In this case, the content of 1,3-dichloropropan-2-ol in the brine before the stripping operation is generally greater than or equal to 0.1 g/kg of brine, often greater than or equal to 0.3 g/kg, frequently greater than or equal to 0.4 g/kg, in a lot of cases greater than or equal to 0.6 g/kg and more specifically greater than or equal to 0.8 g/kg. This content is generally less than or equal to 50 g/kg, often less than or equal to 30 g/kg, frequently less than or equal to 20 g/kg and more specifically less than or equal to 10 g/kg. In this case, the content of 2,3-dichloropropan-1-ol in the brine before the stripping operation is generally greater than or equal to 0.1 g/kg of brine, often greater than or equal to 1 g/kg, in a lot of cases greater than or equal to 2 g/kg and more specifically greater than or equal to 4 g/kg. This content is generally less than or equal to 50 g/kg, often less than or equal to 30 g/kg and frequently less than or equal to 20 g/kg.

In the process according to the invention, the brine may originate from any process that generates a brine containing an organic compound. Examples of such processes are the processes for manufacturing epoxides, in particular ethylene oxide, propylene oxide, butylene oxide or epichlorohydrin, the processes for manufacturing a derivative of an epoxide, in particular epoxy resins, the processes for manufacturing chlorinated organic products, in particular 1,2-dichloroethane, the processes for manufacturing monoisocyanates and polyisocyanates, in particular 4,4′-methylenediphenyl diisocyanate (MDI), toluene diisocyanate (TDI) or hexamethylene-1,6-diisocyanate (HDI) and the processes for manufacturing polycarbonates, in particular 2,2-bis(4-hydroxyphenyl)propane polycarbonate (bisphenol A polycarbonate). The brine may be a combination of brines originating from at least two of these processes. The derivatives of an epoxide, in particular of epichlorohydrin, and the epoxy resins, may be as described in application WO 2008/152044 in the name of SOLVAY (SociétéAnonyme), of which the content, and more specifically the passage from page 13, line 22, to page 44, line 8, is incorporated herein by reference.

In the process according to the invention, the brine preferably originates from a process for manufacturing epichlorohydrin, from a process for manufacturing epoxy resins, from a process for manufacturing 1,2-dichloroethane, or from a combination of at least two of these processes.

In the process according to the invention, the brine more preferably originates from a process for manufacturing epichlorohydrin, more preferably still from a process for manufacturing epichlorohydrin by dehydrochlorination of dichloropropanol, and very particularly preferably from a process for manufacturing epichlorohydrin by dehydrochlorination of dichloropropanol in which at least one portion of the dichloropropanol was obtained from glycerol and of which at least one fraction of said glycerol is natural glycerol. The expression “natural glycerol” is understood to mean glycerol which has been obtained from renewable raw materials. Natural glycerol is as described in application WO 2006/100312 in the name of SOLVAY (Société Anonyme), of which the content, and more specifically the passage from page 4, line 22, to page 5, line 24, is incorporated herein by reference. In this case, the organic compound present in the brine is preferably chosen from the group constituted of epichlorohydrin, dichloropropanols and mixtures of at least two thereof. In this case, the brine may contain at least one other organic compound chosen from the group constituted of acetone, acrolein, 2-butanone, isopropanol, 3-methoxy-1,2-epoxypropane, cyclopentanone, epichlorohydrin, chloroacetone, hydroxyacetone (acetol), the compound of empirical formula: C₆H₁₂O, 1,2,3-trichloropropane, 2,3-epoxy-1-propanol(glycidol), 2-chloro-2-propen-1-ol, cis-3-chloro-2-propen-1-ol, 1-methoxy-3-chloropropan-2-ol, 3-chloro-1-propan-1-ol, trans-3-chloro-2-propen-1-ol, the compound of empirical formula: C₆H₈O₂, the compound of empirical formula: C₆H₁₂OCl₂, the compound of empirical formula: C₆H₁₀O₂Cl₂, 1,3-dichloro-2-propanol, the compound of empirical formula: C₉H₁₀O₂, 2,3-dichloro-1-propanol, phenol, glycerol, 1-chloro-2,3-propanediol, 2-chloro-1,3-propanediol, cyclic diglycerols, glyceraldehyde, formaldehyde, acetaldehyde, propionaldehyde, butyraldehyde, acetic acid, propionic acid, formic acid, glycolic acid, oxalic acid, lactic acid, capric acid, caprylic acid, valeric acid, caproic acid, lauric acid, and mixtures of at least two thereof.

The processes for preparing epoxy resins, dichloropropanol and epichlorohydrin can be such as disclosed in International applications

WO2005/054167, WO2006/100311, WO2006/100312, WO2006/100313, WO2006/100314, WO2006/100315, WO2006/100316, WO2006/100317, WO2006/106153, WO2007/054505, WO 2006/100318, WO2006/100319, WO2006/100320, WO 2006/106154, WO2006/106155, WO 2007/144335, WO 2008/107468, WO 2008/101866, WO 2008/145729, WO 2008/110588, WO 2008/152045, WO 2008/152043, WO 2009/000773, WO 2009/043796, WO 2009/121853, WO 2008/152044, WO 2009/077528, WO 2010/066660, WO 2010/029039, WO 2010/029153, WO 2011/054769 and WO 2011/054770, filed in the name of SOLVAY, the contents of which are incorporated herein by reference.

In the process according to the invention, when the brine originates from a process for manufacturing epichlorohydrin by dehydrochlorination of dichloropropanol, the brine purification process makes it possible both to recover valuable epichlorohydrin and to obtain a brine that is purified of organic compounds which may feed an electrolysis process, in particular a process for the electrolysis of brines of alkali metal chlorides, in particular sodium chloride, such as a chlor-alkali electrolysis process.

In the process according to the invention, at least one stripping zone is fed with a brine comprising at least one organic compound and at least one stripping agent.

The expression “stripping zone” is understood to mean the zone between the feeding and the withdrawal of the brine and of the stripping agent.

The term “stripping” is understood to mean the separation of a substance by entrainment using a gas, the vapour of a pure material or a mixture thereof, denoted by the term “stripping agent”, which dissolves or does not dissolve said substance.

In the process according to the invention, the stripping agent may be chosen from the group constituted of air, oxygen-depleted air, nitrogen, oxygen, steam and mixtures of at least two thereof. Steam, air, oxygen-depleted air and nitrogen are preferred stripping agents and steam is a more preferred stripping agent. A mixture of steam and oxygen-depleted air may also be suitable.

When the stripping agent contains steam, the stripping agent may feed the stripping zone independently of the brine or from the brine itself, or via a combination of the two. Feeding the stripping agent from the brine is very suitable. When the stripping agent feeds the stripping zone independently of the brine, in part or wholly, said part or whole may be of any origin. In particular, when the brine originates at least partly from a process for manufacturing epichlorohydrin, the stripping agent may originate from any step of the process for manufacturing epichlorohydrin, in particular from the step of producing dichloropropanol from glycerol. In this case, the vapour is generated in the steps of cooling and/or condensing the streams from the dichloropropanol production plant.

In the process according to the invention, when the stripping zone is constituted of a stripping column, when the stripping agent is steam that feeds the stripping zone from the brine, the steam is generated from the brine and this generation may take place in the column either by virtue of an internal heat exchanger such as a coil, for example, or via an external heat exchanger such as a reboiler for example. In the process according to the invention, when the stripping zone is constituted of a stripping column, when the stripping agent is steam, the steam is preferably introduced independently of the brine directly into the column with no reboiler via a steam distribution network.

In the process according to the invention, when the stripping agent is steam, the temperature of the coldest fraction of the two fractions withdrawn from the stripping zone (T2) is generally greater than or equal to 10° C., often greater than or equal to 30° C., frequently greater than or equal to 50° C. and more specifically greater than or equal to 80° C. This temperature is generally less than 160° C., often less than or equal to 150° C., frequently less than or equal to 140° C., more specifically less than or equal to 120° C. and in particular less than or equal to 100° C.

In the process according to the invention, when the stripping agent is oxygen-depleted air or nitrogen, the temperature of the coldest fraction of the two fractions withdrawn from the stripping zone (T2) is generally greater than or equal to 10° C., often greater than or equal to 15° C., frequently greater than or equal to 20° C. and more specifically greater than or equal to 25° C. This temperature is generally less than 160° C., often less than or equal to 120° C., frequently less than or equal to 100° C., more specifically less than or equal to 80° C. and in particular less than or equal to 60° C.

In the process according to the invention, when the stripping zone consists of a stripping column, and when the stripping agent is steam, the temperature of the coldest fraction of the two fractions withdrawn from the stripping column is as mentioned in the preceding paragraph for the temperature of the coldest fraction of the two fractions withdrawn from the stripping zone when the stripping agent is steam. The coldest fraction may be withdrawn at the top or at the bottom of the column, and is preferably withdrawn at the top of the stripping column.

In the process according to the invention, when the stripping zone consists of a stripping column, and when the stripping agent is oxygen-depleted air or nitrogen, the temperature of the coldest fraction of the two fractions withdrawn from the stripping column is as mentioned in the preceding paragraph for the temperature of the coldest fraction of the two fractions withdrawn from the stripping zone when the stripping agent is oxygen-depleted air or nitrogen. The coldest fraction may be withdrawn at the top or at the bottom of the column, and is preferably withdrawn at the bottom of the stripping column.

In the process according to the invention, when the stripping agent is steam, the temperature of the hottest fraction of the two fractions withdrawn from the stripping zone is generally greater than 40° C., often greater than or equal to 50° C., frequently greater than or equal to 60° C. and more specifically greater than or equal to 90° C. This temperature is generally less than or equal to 160° C., often less than or equal to 150° C., frequently less than or equal to 140° C., more specifically less than or equal to 130° C. and in particular less than or equal to 120° C.

In the process according to the invention, when the stripping agent is oxygen-depleted air or nitrogen, the temperature of the hottest fraction of the two fractions withdrawn from the stripping zone is generally greater than 15° C., often greater than or equal to 25° C., frequently greater than or equal to 40° C. and more specifically greater than or equal to 60° C. This temperature is generally less than or equal to 160° C., often less than or equal to 150° C., frequently less than or equal to 140° C., more specifically less than or equal to 130° C. and in particular less than or equal to 120° C.

In the process according to the invention, when the stripping zone is a stripping column, and when the stripping agent is steam, the temperature of the hottest fraction of the two fractions withdrawn from the stripping column is as mentioned in the preceding paragraph for the temperature of the hottest fraction of the two fractions withdrawn from the stripping zone when the stripping agent is steam. The hottest fraction may be withdrawn at the top or at the bottom of the column, and is preferably withdrawn at the bottom of the stripping column.

In the process according to the invention, when the stripping zone is a stripping column, and when the stripping agent is oxygen-depleted air or nitrogen, the temperature of the hottest fraction of the two fractions withdrawn from the stripping column is as mentioned in the preceding paragraph for the temperature of the hottest fraction of the two fractions withdrawn from the stripping zone when the stripping agent is oxygen-depleted air or nitrogen. The hottest fraction may be withdrawn at the top or at the bottom of the column, and is preferably withdrawn at the top of the stripping column.

In the process according to the invention, when the stripping agent is chosen from the group constituted of air, oxygen-depleted air, nitrogen, oxygen, and mixtures of at least two thereof, and also mixtures thereof with steam, the temperature of the coldest fraction of the two fractions withdrawn from the stripping zone (T2) is generally greater than or equal to 10° C., often greater than or equal to 25° C., frequently greater than or equal to 40° C. and more specifically greater than or equal to 50° C. This temperature is generally less than 120° C., often less than or equal to 110° C., frequently less than or equal to 105° C. and more specifically less than or equal to 100° C.

In the process according to the invention, when the stripping zone is a stripping column, and when the stripping agent is chosen from the group constituted of air, oxygen-depleted air, nitrogen, oxygen, and mixtures of at least two thereof, and also mixtures thereof with steam, the temperature of the coldest fraction of the two fractions withdrawn from the stripping column is as mentioned in the preceding paragraph for the temperature of the coldest fraction of the two fractions withdrawn from the stripping zone when the stripping agent is chosen from the group constituted of air, oxygen-depleted air, nitrogen, oxygen, and mixtures of at least two thereof, and also mixtures thereof with steam.

In the process according to the invention, when the stripping agent is chosen from the group constituted of air, oxygen-depleted air, nitrogen, oxygen, and mixtures of at least two thereof, and also mixtures thereof with steam, the temperature of the hottest fraction of the two fractions withdrawn from the stripping zone is generally greater than or equal to 15° C., often greater than or equal to 30° C., frequently greater than or equal to 40° C. and more specifically greater than or equal to 60° C. This temperature is generally less than 120° C., often less than or equal to 110° C., frequently less than or equal to 105° C. and more specifically less than or equal to 100° C.

In the process according to the invention, when the stripping zone consists of a stripping column, and when the stripping agent is chosen from the group constituted of air, oxygen-depleted air, nitrogen, oxygen, and mixtures of at least two thereof, and also mixtures thereof with steam, the temperature of the hottest fraction of the two fractions withdrawn from the stripping column is as mentioned in the preceding paragraph for the temperature of the hottest fraction of the two fractions withdrawn from the stripping zone when the stripping agent is chosen from the group constituted of air, oxygen-depleted air, nitrogen, oxygen, and mixtures of at least two thereof, and also mixtures thereof with steam.

In the process according to the invention, the temperatures T₁ and T₂ of the hottest fraction and of the coldest fraction withdrawn from the stripping zone are the temperatures measured before any possible thermal conditioning which might be carried out before and/or during the withdrawal thereof.

These temperatures may be measured using any known type of temperature probe: thermocouple sensor, thermoresistive sensor, infrared sensor, bimetallic sensor, thermometers, etc. Such types of probe are for example described in “Perry's Chemical Engineers' Handbook”, Sixth Edition, McGraw Hill, 1984, Section 22-32 to 22-37.

In the process according to the invention, the fraction (I) essentially constituted of brine contains more than 500 g of brine per kg of fraction (I), often at least 750 g/kg, frequently at least 900 g/kg and more specifically at least 990 g/kg.

In the process according to the invention, the fraction (II) essentially constituted of stripping agent contains more than 50 mol % of stripping agent per mole of fraction (II), often at least 75 mol %, frequently at least 90 mol %, specifically at least 99 mol %.

The temperature may be measured at any location of the fractions withdrawn from the stripping zone. This measurement is preferably carried out within the fractions withdrawn.

In the process according to the invention, the pressure in the stripping zone is generally greater than or equal to 20 mbar absolute, in a lot of cases greater than or equal to 50 mbar absolute, often greater than or equal to 100 mbar absolute, frequently greater than or equal to 200 mbar absolute, more specifically greater than or equal to 400 mbar absolute and in particular greater than or equal to 500 mbar absolute. This pressure is generally less than or equal to 10 bar absolute, often less than or equal to 5 bar absolute, frequently less than or equal to 2 bar absolute, more specifically less than or equal to 1.5 bar absolute and in particular less than or equal to 1.2 bar absolute. A pressure greater than or equal to 600 mbar absolute and less than or equal to 1.1 bar absolute is very suitable.

In the process according to the invention, when the stripping zone is a stripping column, the pressure in the stripping column is as mentioned in the preceding paragraph for the pressure in the stripping zone.

In the process according to the invention, when the stripping zone is a stripping column, the pressure drop i.e. the difference between the pressure at the bottom of the column and the pressure at the top of the column is generally less than or equal to 2 bar, in a lot of cases less than or equal to 1.5 bar, often less than or equal to 1.2 bar, frequently less than or equal to 1 bar, in many cases less than or equal to 0.7 bar and in particular less than or equal to 0.5 bar. This pressure difference is generally greater than or equal to 10 mbar, often greater than or equal to 20 mbar, frequently greater than or equal to 30 mbar, and in particular greater than or equal to 50 mbar.

In the process according to the invention, the stripping may be carried out in continuous mode or in batch mode. The expression “continuous mode” is understood to mean a mode in which the brine and the stripping agent feed the stripping zone in an uninterrupted manner over a period of time covering at least 50% of the duration of the stripping operation, preferably at least 90% of this duration and more preferably at least 95% of this duration. The duration of the stripping operation is the time elapsed between the moment when the feeding of the stripping zone with brine and with stripping agent begins and the moment when this feeding is interrupted. The expression “batch mode” is understood to mean any other operating mode. The stripping is preferably carried out in continuous mode.

In the process according to the invention when the stripping is carried out continuously, the stripping agent and the brine may feed the stripping zone co currently or counter currently or in a crossed current manner. Countercurrent feeding of the stripping zone is preferred.

In the process according to the invention, the stripping agent is preferably steam and the stripping zone from (b) is fed continuously and counter currently with brine and with stripping agent.

In the process according to the invention, when the stripping operation is carried out continuously, the direction of movement of the streams of stripping agent and of brine may be vertical or horizontal, or vertical for the stream of brine and horizontal for the stream of stripping agent or horizontal for the stream of brine and vertical for the stream of stripping agent. A vertical direction of movement for the two streams is preferred.

In the process according to the invention, the ratio between the total amount of stripping agent that is introduced during the stripping operation, expressed in kmol, and the amount of brine that is introduced during the stripping operation, expressed in kmol, is generally greater than or equal to 0.0001, frequently greater than or equal to 0.001, often greater than or equal to 0.01, in particular greater than or equal to 0.05 and more specifically greater than or equal to 0.1. This ratio is generally less than or equal to 10, frequently less than or equal to 5, often less than or equal to 1, in particular less than or equal to 0.5 and more specifically less than or equal to 0.3. The number of kmol of brine corresponds to the sum of the numbers of moles of the constituents of the brine.

In one particular embodiment of the process according to the invention, it is possible to feed the stripping zone or the stripping column with, besides the stripping agent and the brine, at least one basic compound. The basic compound may be an organic basic compound or an inorganic basic compound or a mixture of the two. Organic basic compounds are, for example, amines, such as for example imidazole and derivatives thereof, pyridine and derivatives thereof, phosphines and ammonium, phosphonium or arsonium hydroxides. Inorganic basic compounds are preferred. The expression “inorganic compounds” is understood to mean compounds which do not contain a carbon-hydrogen bond. The inorganic basic compound may be chosen from alkali metal oxides, hydroxides, carbonates, hydrogen carbonates, phosphates, hydrogen phosphates and borates, alkaline-earth metal oxides, hydroxides, carbonates, hydrogen carbonates, phosphates, hydrogen phosphates and borates, and mixtures of at least two thereof. Alkali metal oxides, alkali metal hydroxides, alkaline-earth metal oxides, alkaline-earth metal hydroxides, and mixtures of at least two thereof, are preferred.

In the process according to the invention, the basic compound may be in the form of a liquid, an essentially anhydrous solid, a hydrated solid, an aqueous and/or organic solution or an aqueous and/or organic suspension. The basic compound is preferably in the form of an essentially anhydrous solid, a hydrated solid, an aqueous solution or an aqueous suspension.

The expression “essentially anhydrous solid” is understood to mean a solid for which the water content is less than or equal to 20 g/kg, preferably less than or equal to 10 g/kg and more preferably less than or equal to 1 g/kg.

The expression “hydrated solid” is understood to mean a solid for which the water content is at least 20 g/kg and at most 700 g/kg, preferably at least 50 g/kg and at most 650 g/kg and very particularly preferably at least 130 g/kg and at most 630 g/kg. The hydrates which denote solid combinations of substances with one or more water molecules are examples of hydrated solids.

When the basic compound is used in the form of an aqueous solution, its content in the aqueous solution is generally greater than 20 g/kg, preferably greater than or equal to 70 g/kg and more preferably greater than or equal to 150 g/kg. This content is generally less than or equal to the solubility of the basic solid in the brine at the temperature of the stripping treatment.

When the basic compound is used in the form of an aqueous solution of sodium hydroxide, the content of sodium hydroxide is preferably greater than or equal to 150 g/kg.

When the basic compound is used in the form of an aqueous suspension, its content in the aqueous suspension is generally greater than the solubility of the basic solid in the brine at the temperature of the stripping treatment, preferably greater than or equal to 20 g/kg and more preferably greater than or equal to 70 g/kg. This content is generally less than or equal to 400 g/kg, preferably less than 300 g/kg.

The preferred basic compounds are in the form of concentrated aqueous solutions or suspensions of sodium hydroxide or calcium hydroxide or in the form of purified caustic brine. The expression “purified caustic brine” here means sodium hydroxide which contains sodium chloride such as, for example, that produced in a diaphragm electrolysis process. The sodium hydroxide content of the purified caustic brine is generally greater than or equal to 30 g/kg, preferably greater than or equal to 40 g/kg and more preferably greater than or equal to 60 g/kg. This sodium hydroxide content is generally less than or equal to 300 g/kg, preferably less than or equal to 250 g/kg and more preferably less than or equal to 200 g/kg. The sodium chloride content of the purified caustic brine is generally greater than or equal to 30 g/kg, preferably greater than or equal to 50 g/kg and more preferably greater than or equal to 70 g/kg. This sodium chloride content is generally less than or equal to 250 g/kg, preferably less than or equal to 200 g/kg and more preferably less than or equal to 180 g/kg.

It is also possible to use a mixture of several basic agents depending on the availabilities and on the economic optimization of the industrial site where the process according to the invention is established. The basic agents preferred for producing these mixtures are limewater and solutions of sodium hydroxide and of purified caustic brine, for example, a mixture of limewater and a sodium hydroxide solution or a mixture of limewater and purified caustic brine. These mixtures may be produced in any relative proportion of at least two of these basic agents. They may be produced both before introduction into the stripping zone and also in this stripping zone.

The use of a basic agent is very suitable when, in the process according to the invention, the brine originates from a process for manufacturing epichlorohydrin by dehydrochlorination of dichloropropanol and when the organic compound in the brine is chosen from mixtures of epichlorohydrin and dichloropropanols. In this case the addition of a basic agent makes it possible to convert at least one portion of the dichloropropanols present in the brine to epichlorohydrin, a valuable product that is also more easily stripped. In this case, not only is the brine purified of organic compounds but in addition a valuable organic product is recovered. In this case, the brine generally contains, before stripping, organic compounds other than epichlorohydrin and dichloropropanols, such as for example monochloropropanediols, glycidol and chloroacetone. These other organic compounds may be converted to glycerol and to hydroxyacetone, which are less readily stripped, less toxic and more readily degradable, via a biological route and/or via a chemical route. The risk of contamination of the stripped epichlorohydrin by these other organic compounds is reduced and the reuse of the epichlorohydrin recovered there from is facilitated.

In the process according to the invention, when the stripping zone or the stripping column is fed with at least one basic agent, and when the organic compound in the brine is chosen from mixtures of epichlorohydrin and dichloropropanols, the ratio between the total amount of basic agent that is introduced during the stripping operation, expressed in equivalents, and the amount of dichloropropanol contained in the brine before the stripping, expressed in moles, is generally greater than or equal to 0.1, frequently greater than or equal to 0.5 and often greater than or equal to 1. This ratio is generally less than or equal to 20, frequently less than or equal to 10, often less than or equal to 5 and in particular less than or equal to 2.

In this embodiment, the epichlorohydrin present in the brine may react with the alkaline agent added. One preferred operating mode consists in dividing the stripping into two parts: a first part where the epichlorohydrin fed into the brine is stripped, then a second reactive part where the dichloropropanol reacts with the alkaline agent and the epichlorohydrin formed is stripped. The alkaline agent is introduced between the two parts. These two parts may be carried out in one and the same device, by way of non-limiting example, a two-section column, or in different devices, by way of non-limiting example, two separate columns.

When the stripping zone or the stripping column is fed with at least one basic compound, the basic compound may feed the stripping zone independently of the brine or from the brine itself, or via a combination of the two. Feeding of the basic agent from the brine is carried out by addition of the basic agent to the brine before the latter is fed into the stripping zone. Any type of mixer may be used to homogenize the resulting mixture, such as for example, a static mixer, a dynamic mixer, a stirred tank, etc.

In the process according to the invention, the stripping zone may comprise any type of apparatus or combination of apparatus as described in “Perry's Chemical Engineers' Handbook”, Sixth Edition, McGraw Hill, 1984, Section 14.

In one particular embodiment of the process of the invention, the stripping zone consists of a stripping column.

In a first aspect of this particular embodiment, a single stripping column is fed with the brine and the stripping agent, counter currently, and the direction of movement of the streams of brine and stripping agent is vertical. The brine is introduced at the top of the column and withdrawn from the bottom of the column. The stripping agent, preferably steam, is introduced at the bottom of the column and withdrawn from the top of the column.

In a second aspect of this particular embodiment, at least two stripping columns are fed in series with the brine and the stripping agent, counter currently, and the direction of movement of the streams of brine and stripping agent is vertical. The brine is introduced at the top of the columns and withdrawn from the bottom of the columns. The stripping agent, preferably steam, is introduced at the bottom of the columns and withdrawn from the top of the columns.

In a third aspect of this particular embodiment, at least two stripping columns are fed in parallel with the brine and the stripping agent, counter currently, and the direction of movement of the streams of brine and stripping agent is vertical. The brine is introduced at the top of the columns and withdrawn from the bottom of the columns. The stripping agent, preferably steam, is introduced at the bottom of the columns and withdrawn from the top of the columns.

In a fourth aspect of this particular embodiment, at least two stripping columns are fed with the brine and the stripping agent, counter currently, and the direction of movement of the streams of brine and stripping agent is vertical. The columns are fed in parallel by the brine and in series by the stripping agent. The brine is introduced at the top of the columns and withdrawn from the bottom of the columns. The stripping agent, preferably steam, is introduced at the bottom of the columns and withdrawn from the top of the columns.

In a fifth aspect of this particular embodiment, at least two stripping columns are fed with the brine and the stripping agent, counter currently, and the direction of movement of the streams of brine and stripping agent is vertical. The columns are fed in series by the brine and in parallel by the stripping agent. The brine is introduced at the top of the columns and withdrawn from the bottom of the columns. The stripping agent, preferably steam, is introduced at the bottom of the columns and withdrawn from the top of the columns.

In a sixth aspect of this particular embodiment, a single stripping column is fed with the brine and the stripping agent, counter currently, and the direction of movement of the streams of brine and stripping agent is vertical. The brine is introduced at the top of the column at various levels and withdrawn from the bottom of the column at various levels. The stripping agent, preferably steam, is introduced at the bottom of the column at various levels and withdrawn from the top of the column at various levels.

When a basic agent is used, this agent is habitually added at one or more intermediate levels, and often at a single level, to the stripping column. When the basic agent is added at a single level, said level is more specifically located above or below the brine feed point. When the basic agent is added at several levels, said levels are more specifically located below the brine feed point, it being possible for one of the levels to be located above the brine feed point and the others below.

The basic agent may also be introduced into the brine feeding the stripping column.

When the stripping zone consists of a stripping column, this generally comprises plates or packing or both. The stripping column preferably comprises packing in its upper part and plates in its lower part. More preferably, the packing extends from a level located below the brine feed point to the top of the column and the plates are located below the packing. More preferably still, the retention of the plates increases on descending the column.

In the process according to the invention, the stripping column very particularly preferably comprises packing in its upper part and plates in its lower part, and the brine is fed into the top of the column and the packing is located below the brine feed point and the retention of the plates increases towards the bottom of the column.

The plates may be of any type known to a person skilled in the art, for example perforated plates, bubble-cap trays, valve trays, and “doughnut” trays. Perforated plates are very suitable.

The number of plates is generally greater than or equal to 3, often greater than or equal to 5, frequently greater than or equal to 8 and in particular greater than or equal to 12. This number of plates is generally less than or equal to 100, often less than or equal to 80, frequently less than or equal to 50 and in particular less than or equal to 40. A number of plates between 18 and 25 is very suitable.

The packings may be of any type known to a person skilled in the art such as random packings and structured packings. Random packings are very suitable.

The packing height is generally greater than or equal to 0.5 m, often greater than or equal to 1 m and frequently greater than or equal to 2 m. This height is generally less than or equal to 10 m, often less than or equal to 8 m, frequently less than or equal to 5 m and in particular less than or equal to 4 m. A height between 2.5 and 3.5 m is very suitable.

The apparatus in which the stripping treatment is carried out, such as for example the stripping column, the packing and the plates of the column, is generally made from or covered with a material that withstands the stripping conditions. This material may be chosen from the group constituted of carbon steels, stainless steels, enamelled steels, compressed steels, titanium, titanium alloys and nickel alloys, polymers, such as polyolefins, for instance polypropylene and polyethylene, such as chlorinated polymers, for instance polyvinyl chloride and chlorinated polyvinyl chloride, such as fluorinated polymers, for instance perfluorinated polymers including, for example, polytetrafluoroethylene, copolymers of tetrafluorethylene and hexafluoropropylene, and poly(perfluoropropyl vinyl ether), for instance partially fluorinated polymers including, for example, polyvinylidene fluoride and copolymers of ethylene and chlorotrifluoroethylene, such as sulphur-containing polymers, for instance polysulphones and polysulphides, in particular that are aromatic, coatings using resins such as epoxy resins and phenolic resins, and combinations of at least two thereof. The polymers may be used in bulk or shrunk-fit form or in the form of a coating.

In the process according to the invention, the fraction of stripping agent withdrawn (II) comprises the stripping agent and a first portion of the organic compound present in the brine before the feeding of the stripping zone. The fraction of brine withdrawn (I), the content of organic compound of which is lower than in the brine which feeds the stripping zone, comprises brine and a second portion of the organic compound present in the brine before the stripping operation.

In the process according to the invention, the amount of organic compound present in the fraction withdrawn (II) is generally greater than or equal to 80% of the amount of organic compound present in the brine which feeds the stripping zone, often greater than or equal to 85%, frequently greater than or equal to 90% and in many cases greater than or equal to 94%.

In the process according to the invention, when the organic compound in the brine is chosen from mixtures of epichlorohydrin and of dichloropropanols, the amount of dichloropropanols present in the fraction withdrawn (I) relative to the amount of dichloropropanols present in the brine which feeds the stripping zone is generally less than or equal to 5%, often less than or equal to 1%, frequently less than or equal to 0.1% and in many cases less than or equal to 0.05%.

In the process according to the invention, the content of organic compound in the fraction withdrawn (I) expressed as g of carbon per kg of fraction withdrawn (I) is generally less than or equal to 10 g/kg, preferably less than or equal to 5 g/kg, more preferably less than or equal to 2 g/kg, even more preferably less than or equal to 1 g/kg, and more preferably still less than or equal to 0.8 g/kg. This amount is generally greater than or equal to 0.0001 g/kg.

In the process according to the invention, when the organic compound is chosen from the group constituted of epichlorohydrin, dichloropropanols and mixtures of at least two thereof and in particular when the organic compound is a mixture of epichlorohydrin and dichloropropanols, the content of organic compound in the fraction withdrawn (I) expressed as g of carbon per kg of fraction withdrawn (I) is generally less than or equal to 10 g/kg, preferably less than or equal to 5 g/kg, more preferably less than or equal to 2 g/kg, even more preferably less than or equal to 1 g/kg, and more preferably still less than or equal to 0.8 g/kg. This amount is generally greater than or equal to 0.0001 g/kg. In this case, the content of epichlorohydrin in the fraction withdrawn (I) expressed as g of carbon per kg of fraction withdrawn (I) is generally less than 0.5 g of carbon/kg of fraction withdrawn (I) and preferably less than or equal to 0.1 g/kg. In this case, the content of dichloropropanols in the fraction withdrawn (I) expressed as g of carbon per kg of fraction withdrawn (I) is generally less than 0.5 g/kg, and preferably less than or equal to 0.1 g/kg.

In the process according to the invention, the fraction withdrawn (II) may be subjected to any subsequent treatment. This treatment may be chosen from the group constituted of distillation, evaporation, stripping, liquid/liquid extraction, settling, adsorption and absorption operations and any combination of at least two thereof. This subsequent treatment is generally intended to recover, in a first portion, the majority of the organic compound present in the fraction withdrawn (II) before the subsequent treatment and, in a second portion, the majority of the stripping agent present in the fraction withdrawn (II) before the subsequent treatment. The second portion may be recycled to the stripping zone. When the stripping agent comprises steam, a condensation operation followed by a liquid/liquid phase separation operation, for example by centrifugation, by coalescence or by gravity settling, is preferred. In certain cases, the settling operation may be preceded by a coalescence operation. This operation is preferred when the organic compound is chosen from the group constituted of epichlorohydrin, dichloropropanols or mixtures of epichlorohydrin and dichloropropanol. When the stripping agent is chosen from the group constituted of air, nitrogen, oxygen, oxygen-depleted air, and mixtures of at least two thereof, an adsorption of the organic compound onto an adsorbent solid, such as for example activated carbon or a resin is a preferred variant. Another preferred variant is sending to a high-temperature oxidation treatment.

In the process according to the invention, the fraction withdrawn (I) may be subjected to any subsequent treatment. This treatment may be chosen from the group constituted of thermal conditioning, dilution, concentration, distillation, evaporation, settling, coalescence, liquid/liquid extraction, filtration, crystallization, adsorption, oxidation, reduction, neutralization, complexation, precipitation and salt addition operations and combinations of at least two thereof. These treatments are as described in application WO 2008/152043 by SOLVAY (Société Anonyme), of which the content, and more specifically the passage from page 11, line 13 to page 29, line 7, is incorporated herein by reference and in application WO 2009/095429 by SOLVAY (Société Anonyme), of which the content, and more specifically the passage from page 1, line 24 to page 27, line 26, is incorporated herein by reference. A treatment that is very suitable is as described in French patent application No. 10/56360 filed on 02 August 2010 in the name of Solvay S. A. and the content of which is incorporated herein by reference. The fraction (I) thus treated is a brine purified of organic compounds that may feed an electrolysis process, in particular a process for the electrolysis of brines of alkali metal chlorides, in particular sodium chloride, such as a chlor-alkali electrolysis process.

In the process according to the invention, particularly when the stripping zone is a stripping column, a brine depleted in organic compounds is withdrawn from the stripping zone, particularly from the stripping column, and it is possible to subject said depleted brine to at least one treatment chosen from the group constituted of thermal conditioning, dilution, concentration, distillation, evaporation, liquid/liquid extraction, filtration, crystallization, adsorption, oxidation, reduction, neutralization, complexation, precipitation, salt addition, aerobic bacterial treatment and anaerobic bacterial treatment operations, and combinations of at least two thereof, and to feed a mercury electrolysis cell or a diaphragm electrolysis cell or a membrane electrolysis cell, preferably a membrane electrolysis cell, of a process for the electrolysis of alkali metal chloride brines, with said thus treated brine.

The invention also relates to a process of electrolysis of brines of alkali metal chlorides, in which a mercury electrolysis cell or a diaphragm electrolysis cell or a membrane electrolysis cell, preferably a membrane electrolysis cell, of a process for the electrolysis of alkali metal chloride brines, is fed with a brine obtained by subjecting to at least one treatment chosen from the group constituted of thermal conditioning, dilution, concentration, distillation, evaporation, liquid/liquid extraction, filtration, crystallization, adsorption, oxidation, reduction, neutralization, complexation, precipitation, salt addition, aerobic bacterial treatment and anaerobic bacterial treatment operations, and combinations of at least two thereof, a brine depleted in organic compounds, the brine being withdrawn from the stripping zone, preferably from the stripping column, of the epuration process according to the invention.

In the process according to the invention, the brine that feeds the stripping zone may be subjected to at least one treatment before feeding the stripping zone. This treatment may be chosen from the group constituted of dilution, concentration, distillation, evaporation, settling, coalescence, liquid/liquid extraction, filtration, crystallization, adsorption, oxidation, reduction, neutralization, complexation and precipitation operations and combinations of at least two thereof. These treatments are as described in application WO 2008/152043 by SOLVAY (Société Anonyme), of which the content, and more specifically the passage from page 11, line 13 to page 29, line 7, is incorporated herein by reference and in application WO 2009/095429 by SOLVAY (Société Anonyme), of which the content, and more specifically the passage from page 1, line 24 to page 27, line 26, is incorporated herein by reference.

Examples 1 to 21 below are intended to illustrate the invention without however limiting it.

### EXAMPLES 1 AND 2

A stripping column comprising 27 plates is fed with a brine comprising, per kg of brine, 20 g of epichlorohydrin, 12 g of 1,3-dichloro-2-propanol, 8 g of 2,3-dichloro-1-propanol and 200 g of sodium chloride, at the fifth plate counting from the top of the column, and with 3 bar absolute saturated steam at the bottom of the column.

The flow of steam that feeds the column relative to the flow of brine that feeds the column is 6/40 kg/kg.

The residence time of the liquid in the column is 45 s on the feed plate, 18 s per plate on the plates located below the feed plate and 4.5 s on the plate at the top of the column.

The brine is withdrawn from the bottom of the column and the steam at the top of the column.

### EXAMPLE 3

The procedure from Example 2 is followed except that the stripping column is also fed with a solution containing 320 g/kg of sodium hydroxide. The flow of sodium hydroxide is adjusted in order to obtain an amount of dichloropropanols present in the brine at the bottom of the column relative to the amount of dichloropropanols present in the brine feeding the column of 0.01%.

### EXAMPLES 4, 10, 11, 12, 13 AND 14

The procedure from example 3 is followed except that the stripping is made with 4 bar absolute saturated steam at the bottom of the column.

### EXAMPLES 5, 6, 7, 8, 9,15, 16, 17, 18, 19, 20 AND 21

The procedure from example 2 is followed except that the stripping is made with 4 bar absolute saturated steam at the bottom of the column.

For Examples 1 to 21, the values of the residual contents of organic compounds in the brine withdrawn, expressed as mg of carbon per kg of brine withdrawn from the bottom of the column and the various values of the pressure at the top of the column, of the pressure drop in the column, of the temperature of the brine withdrawn from the bottom of the column and of the temperature of the steam withdrawn at the top of the column are presented in the table below.

TABLE 1

| | | | | | Residual | |
|---|---|---|---|---|---|---|
| | | | T(brine | T(steam | content of | Accord- |
| | | Pressure | with- | with- | organic | ing |
| | P(top) | drop | drawn) | drawn) | compounds | to the |
| Example | (mbar) | (mbar) | (° C.) | (° C.) | (mg of C/kg) | invention |
| 1 | 40 | 1700 | 118.2 | 29.7 | 4925 | no |
| 2 | 40 | 1200 | 107.9 | 29.7 | 4914 | yes |
| 3 | 40 | 1200 | 108 | 29.4 | 211 | Yes |
| 4 | 30 | 300 | 71.7 | 23.7 | 23 | Yes |
| 5 | 30 | 1400 | 112.2 | 24.8 | 4951 | No |
| 6 | 50 | 2100 | 124.9 | 33.5 | 4918 | No |
| 7 | 70 | 2500 | 130.8 | 39.6 | 4920 | No |
| 8 | 100 | 2700 | 133.7 | 46.3 | 4917 | No |
| 9 | 200 | 3000 | 138.3 | 60.5 | 4935 | No |
| 10 | 50 | 300 | 73.1 | 32.5 | 26 | Yes |
| 11 | 70 | 1400 | 113.1 | 39.4 | 268 | Yes |
| 12 | 100 | 300 | 76.3 | 45.3 | 32 | Yes |
| 13 | 200 | 300 | 81.8 | 59.5 | 48 | Yes |
| 14 | 300 | 300 | 86.4 | 68.5 | 66 | Yes |
| 15 | 300 | 3600 | 145.3 | 69.4 | 5237 | No |
| 16 | 200 | 1900 | 124.2 | 60.7 | 4806 | Yes |
| 17 | 150 | 1500 | 118.4 | 54.7 | 4806 | Yes |
| 18 | 150 | 400 | 84.6 | 54.9 | 4721 | Yes |
| 19 | 100 | 600 | 91.9 | 46.7 | 4785 | Yes |
| 20 | 50 | 1800 | 120.1 | 33.5 | 4906 | Yes |
| 21 | 50 | 1000 | 103.1 | 33.7 | 4884 | Yes |

1. A process for purifying a brine comprising at least one organic compound, said process comprising:
(a) supplying a brine that comprises at least one organic compound;
(b) feeding at least one stripping zone with the brine from step (a) and at least one stripping agent;
(c) withdrawing from said stripping zone at least one fraction (I) consisting essentially constituted of brine, the content of said at least one organic compound being lower in said fraction (I) than in said brine from step (a) and withdrawing from said stripping zone at least one fraction (II) consisting essentially said stripping agent;
wherein the temperature (T₁), expressed in degrees Celsius, of the hotter fraction of the two fractions (I) and (II) and the temperature (T₂), expressed in degrees Celsius, of the colder fraction of the two fractions (I) and (II), said temperatures being the temperatures measured before any optional thermal conditioning which might be carried out before and/or during the withdrawal of said fractions (I) and (II) from said stripping zone, correspond to the following formula:
6×10⁻⁷(T₁)^{3.7294}≦T₂<T₁

2. The process according to claim 1, wherein the temperature T₂ is less than or equal to 0.9752 (T₁)^{0.9991} and greater than or equal to 5 10⁻⁵ (T₁)^{2.8779}.

3. The process according to claim 1, wherein the temperature T₂ is less than or equal to 0.8967 (T₁)^{1.0147} and greater than or equal to 0.0593 (T₁)^{1.4859}.

4. (canceled)

5. (canceled)

6. The process according to claim 1, wherein the temperature T₂ is greater than or equal to 0.5342 (T₁)^{1.088}.

7. The process according to claim 1, wherein the temperature T₂ is greater than or equal to 0.7535 (T₁)^{1.0325}.

8. The process according to claim 1, wherein the stripping zone in step (b) consists of a stripping column, and wherein the difference between the pressure at the bottom of said stripping column and the pressure at the top of said stripping column is less than or equal to 2 bars and greater than or equal to 10 mbars.

9. (canceled)

10. The process according to claim 8, wherein the difference between the pressure at the bottom of said stripping column and the pressure at the top of said stripping column is less than or equal to 1.5 bars and greater than or equal to 30 mbars.

11. The process according to claim 1, wherein said brine contains at least sodium chloride at a content greater than or equal to 5 g of NaCl per kg of brine.

12. The process according to claim 11, wherein the sodium chloride content of said brine is greater than or equal to 180 g of NaCl per kg of brine.

13. The process according to claim 1, wherein said at least one organic compound is selected from the group consisting of epichlorohydrin, dichloropropanols, and any mixture thereof.

14. The process according to claim 13, wherein the content of epichlorohydrin in said brine before stripping is greater than 0.1 g/kg of brine and less than or equal to 100 g/kg of brine.

15. (canceled)

16. The process according to which claim 13, wherein the dichloropropanols are 1,3-dichloropropan-2-ol and 2,3-dichloropropan-1-ol; and wherein the content of 1,3-dichloropropan-2-ol in said brine before stripping is greater than or equal to 0.1 g/kg and less than or equal to 50 g/kg; or wherein the content of 2,3-dichloropropan-1-ol in said brine before stripping is greater than or equal to 0.1 g/kg and less than or equal to 50 g/kg.

17. (canceled)

18. The process according to claim 1, wherein said stripping agent is selected from the group consisting of air, oxygen-depleted air, nitrogen, steam, and mixtures of at least two thereof.

19. The process according to claim 18, wherein the stripping agent is steam, and wherein the stripping zone from step (b) is fed continuously and counter currently with said brine and with said stripping agent.

20. The process according to claim 1, wherein said stripping zone from step (b) is further fed with at least one basic agent selected from the group consisting of alkali metal oxides, alkaline-earth metal oxides, alkali metal hydroxides, alkaline-earth metal hydroxides, and mixtures of at least two thereof.

21. The process according to claim 20, wherein the at least one basic agent is an aqueous solution of sodium hydroxide, and wherein the content of sodium hydroxide of said aqueous solution is greater than or equal to 150 g/kg.

22. The process according to claim 20, wherein the at least one organic compound is a mixture of epichlorohydrin and dichloropropanols, and wherein the ratio between the total amount of said basic agent that is introduced during stripping, expressed in equivalents, and the amount of dichloropropanol contained in the brine before the stripping, expressed in moles, is greater than or equal to 0.1 and less than or equal to 20.

23. The process according to claim 8, wherein said stripping column from step (b) comprises packing in its upper part and plates in its lower part; wherein said brine is fed at a brine feed point into the top of the stripping column, the packing being located below the brine feed point and wherein the retention of the plates increases towards the bottom of the stripping column.

24. The process according to claim 1, wherein said brine originates from a process for manufacturing epichlorohydrin by dehydrochlorination of dichloropropanol; wherein at least one portion of said dichloropropanol is obtained from glycerol, at least one fraction of the glycerol being natural glycerol.

25. A process of electrolysis of brines of alkali metal chlorides, comprising:
providing a brine from the purification process according to claim 1, said brine being withdrawn from the stripping zone of said purification process and being depleted in organic compounds;
subjecting said brine depleted in organic compounds to at least one treatment selected from the group consisting of thermal conditioning, dilution, concentration, distillation, evaporation, liquid/liquid extraction, filtration, crystallization, adsorption, oxidation, reduction, neutralization, complexation, precipitation, salt addition, aerobic bacterial treatment and anaerobic bacterial treatment, and combinations of at least two thereof; and
feeding the treated brine to a membrane electrolysis cell.
